(19) United States
(12) Patent Application Publication
(10) Pub. No.: US 2015/0190913 A1
(43) Pub. Date: Jul. 9, 2015

(54) Automotive Hood Spring Installer/Remover Tool

(71) Applicant: Paul James Williams, Lockport, IL (US)

(72) Inventor: Paul James Williams, Lockport, IL (US)

(21) Appl. No.: 14/594,059

(22) Filed: Jan. 9, 2015

Related U.S. Application Data
(60) Provisional application No. 61/925,645, filed on Jan. 9, 2014.

(51) Int. Cl. B25B 27/30

(52) U.S. Cl. CPC B25B 27/302

(57) ABSTRACT

An apparatus to install or remove tension coil springs from spring seat. Apparatus spans beyond the length of a tension coil spring allowing connection to spring ends with a loop and or hook on a threaded shaft. Applying a turning force to threaded shaft will stretch spring to a longer length allowing removal of spring from spring seat. A turning force in opposite direction retracts spring to shorter length allowing installation of spring to spring seat.

### CROSS-REFERENCE TO RELATED APPLICATIONS

This Application claims the benefit of U.S. Provisional Application No. 61/925,645 filed on Jan. 9, 2014 Titled—Williams Automotive Hood Spring Install/Removal Tool—. The above identified patent application is herein incorporated by reference in its entirety to provide continuity of disclosure.

### STATEMENTS REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA EFS WEB.

Not Applicable

### STATEMENT REGARDING PRIOR DISCLOSURES BY THE INVENTOR OR A JOINT INVENTOR

This Application for Automotive Hood Spring Installer/Remover Tool is claiming the benefits and filing date of U.S. Provisional Application No. 61/925,645 filed on Jan. 9, 2014 titled—Williams Hood Spring Install/Removal Tool.

### BACKGROUND OF THE INVENTION

1. Field of the Invention

The present Invention relates to Mechanical Tools. More specifically the present invention is an improvement to a tool that stretches and or retracts automotive tension coil hood springs to ultimately allow user to remove or install springs attached to vehicle's hood hinge or body of vehicle.

A lot of vehicles made from the 1930's thru mid 1980's, utilized tension coil springs. Installed on hood hinges, springs give hoods a counter balance when hood is raised in the upright position to expose engine bay of vehicle. After years of use springs start to loose strength of spring tension and won't fully hold a hood in upright position. If hood falls due to low spring tension the user can be injured. The proper repair would be to replace the hood spring on vehicle. Present invention would allow safe replacement of springs.

Antique and classic cars are currently being restored back to original condition. In order to restore hinges and springs they need to be checked and possibly replaced. In order to check hinges for wear and play, the springs need to be removed to relieve pressure on hinge assembly. Only then can hinge be checked for wear. Springs and hinges are sold separately and springs need to be stretched for installation onto hinge. Present invention will be able to remove and install spring in those instances.

Aftermarket hood makers offer fiberglass replacement hoods instead of steel hoods for looks and weight reduction for race applications. Fiberglass hoods are significantly lighter in weight which makes the stock hood spring rate too strong for fiberglass hoods. Damage is usually caused near the hinge mounting area on the top surface of the hood due to the spring pushing the hinge up to much when hood is lowered and closed. The fiberglass hood would not have the correct weight of counter balance to spring rate. Cracks in the fiberglass and paint occur in that situation. The correct repair would be to replace the stock hood spring with a low-tension spring that is readily available. Present invention would facilitate removal of old springs and installation of new low-tension springs for a proper, safe repair.

2. Description of Related Art

U.S. Pat. No. 3,747,895A—Martin; Marcus, Nov. 4, 1971—“Spring Extender” can both extend and retract tension coil hood springs as per present invention also does. This patent has the frame as the extendable or moving part to expand spring. Current invention has a one piece or solid frame with the said Externally Threaded Shaft being the spring expander or moveable part. Connection to spring end is different than present invention. Notches are used in related art and hooks a loops are used in present invention being a more stable, secure connection process. Present invention has overall less pieces, so making present tool is less expensive to manufacture while not compromising the strength or reliability of said tool.

U.S. Pat. No. 2,779,087—Alva V. Shahan, Jan. 29, 1957—“Device for installing tension springs on automobile hood hinges.” States it is a ‘stretcher and holder’ for automobile hood springs to aid in the installation of hood springs on to hood hinges. This device consists of two parts. One is a spring stretching device and the other part is an extended spring holding bar. After spring is stretched, user must transfer spring from stretcher on to a said holding bar. Said Holding bar is said used due to cramped quarters encountered where the spring needs to be installed on vehicle. Transferring the spring from one tool to another while spring is under great forces of spring pressure poses a risk of safety for the user. If any slippage occurs and the spring slips off of said holder, the spring recoil pressure can cause spring to strike people or objects in its path causing damage. Present invention always has spring connected to tool until spring is seated on spring seats on vehicle hinge and or body, or the spring is released to relaxed state and able to be easily removed off of tool. Present invention is small enough to fit in said cramped quarters of a vehicles engine bay to install or remove spring directly on to vehicle hinge to complete installation or removal without having to remove vehicle hood or hinge from vehicle.

U.S. Pat. No. 2,589,042A—Walter E. Brennemen, Mar. 11, 1952—“Hood Hinge Spring Remover” is a device that is inserted in to spring coils while hood is in upright position. Once device is inserted in spring, user closes hood to the point where spring locks onto device with spring tension. At that point user must reach under hood and grip spring and tool and remove spring from vehicle's hood hinge. Device will hold spring in extended position until spring is put back on vehicle hood hinge with hood lowered, spring seated in seats and spring tension removed from tool by raising vehicle hood to upright position. Device is unable to stretch or retract spring. Also may pose a safety concern with the angle that spring coils are designed. Point of contact for tool can be compromised due to small contact points and slip off from pressures exerted from spring tension. Present invention securely holds spring ends to eliminate any possible slippage and has the ability to stretch and retract spring safely to eliminate the need for any other device to complete hood hinge spring installation or removal process.

### BRIEF SUMMARY OF THE INVENTION

The technical object of the present disclosure is to provide an improvement for an automobile tension coil hood spring installer/remover. An apparatus to mechanically stretch or retract vehicle's tension coil hood springs. Allowing removal and installation of automobile tension coil hood springs while on vehicle.

### BRIEF DESCRIPTION OF THE SEVERAL VIEWS OF THE DRAWING(S)

FIG. 1 explained:

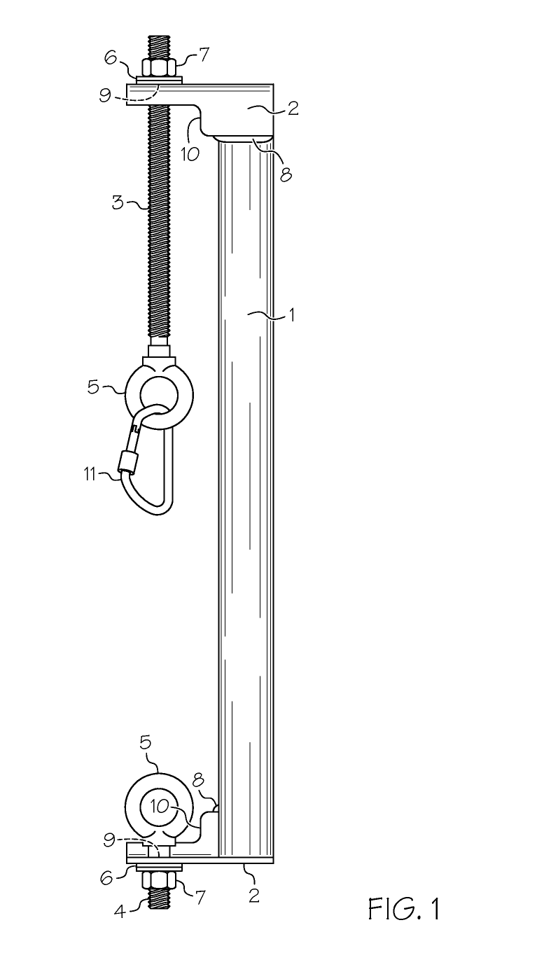

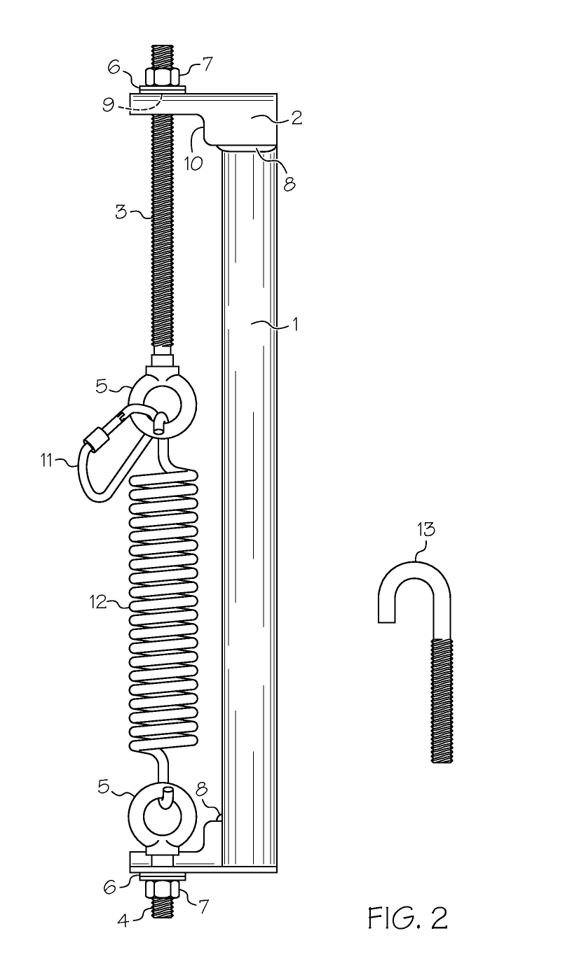

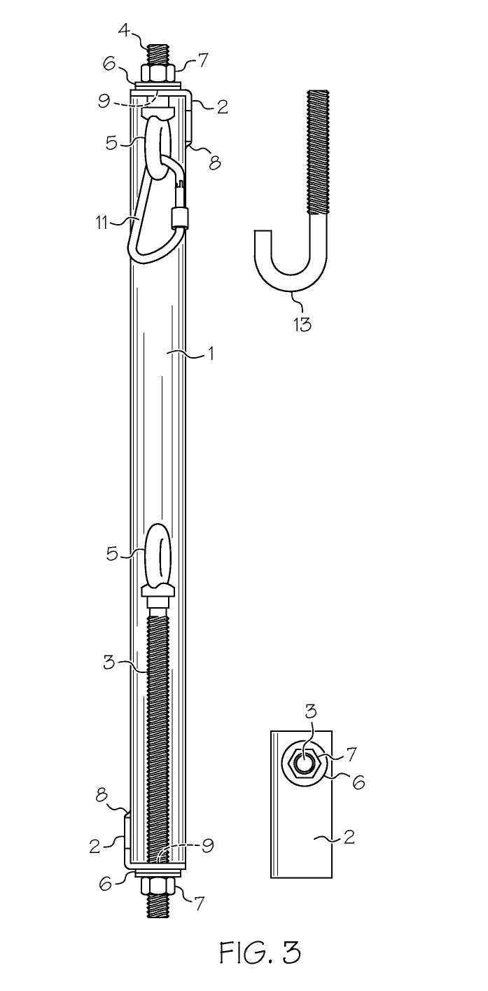

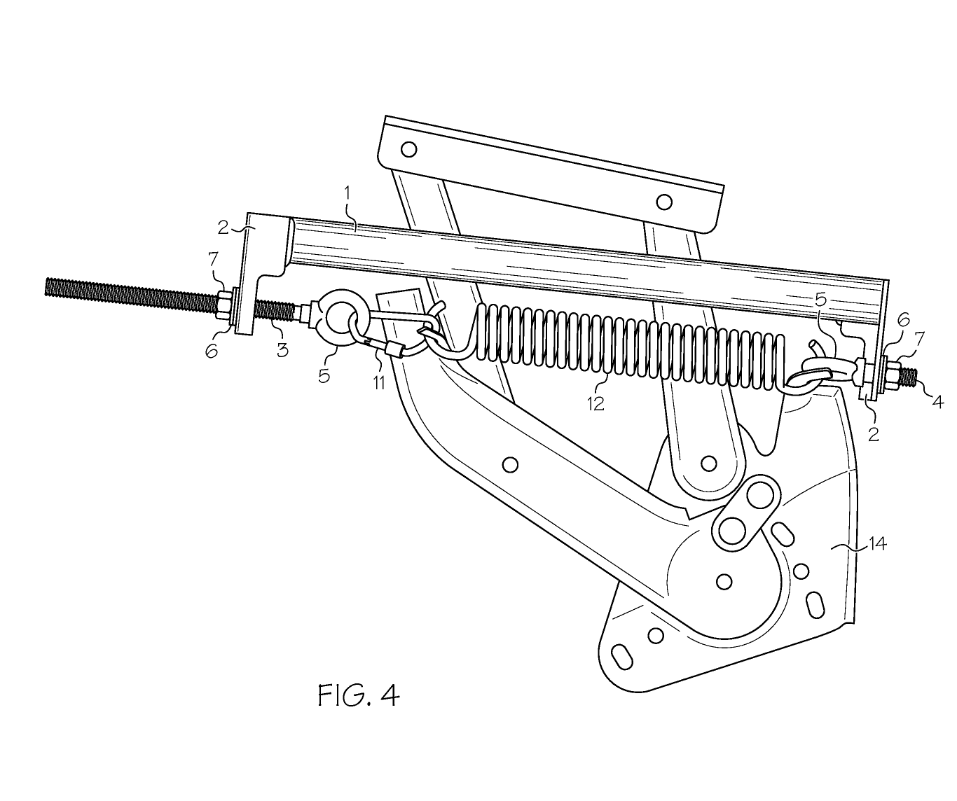

Frame of tool (1) is a schedule 40 cylindrical pipe cut at 15″ long. Frame end brackets (2) are ⅛″ thick, 1″ wide angle iron cut at 3″ long. Frame end brackets (2) are connected to frame of tool (1) by fuse or weld (8) together. Frame end brackets (2) have a ⅜″ drilled hole (9) ¾″ from outer end. Frame end brackets (2) have about 1½″ long×½″ deep notch (10) removed from end bracket side for loop and hook clearance. The Long externally threaded shaft (3) is inserted through ⅜″ hole (9) in frame end bracket (2). Two flat washers (6) are inserted over longer externally threaded shaft (3) end on outward side of frame end bracket (2). Internally threaded hex nut (7) is threaded onto longer externally threaded shaft (3) end. The loop and or hook (5) faces inward in relation to frame end bracket (2). The shorter externally threaded shaft (4) is inserted in opposing frame end bracket (2). Two flat washers (6) are inserted on shorter externally threaded shaft (4) end on outward side of frame end bracket (2). Internally threaded hex nut (7) is threaded onto end of shorter externally threaded shaft (4). The openable and closeable link (11) is connected to longer externally threaded shaft (3) for adaptability on applications where vehicle hood spring (12) is shorter in length as used on some 1970's era vehicles. J-Hook (13) is used in place of shorter externally threaded shaft (5) when access to vehicle spring end hook is obstructed. J-Hook (13) will install on frame (1) and grab spring similar to shorter externally threaded shaft (5) and allow removal and installation of spring (12) in most instances of spring end obstruction. More specifically on 1965-late 1970's Ford Mustangs.

FIG. 2 Explained:

Vehicle hood spring (12) shown connected to present invention without the use of openable and closeable link (11) and J-Hook (13).

FIG. 3 Explained:

Shows an anal view of present invention. Also shows a front view of Frame end bracket (2) with flat washer (6) and internally threaded hex nut (7) installed on external threads of longer externally threaded shaft (3) on outward side of frame end bracket (2). J-Hook (13) is displayed.

FIG. 4 Explained:

Displaying present invention connected to a vehicle hood spring (12) while vehicle spring (12) is still attached to vehicle hood hinge (14) with the use of openable and closeable link (11)

### DETAILED DESCRIPTION OF THE INVENTION

Automotive Hood Spring Installer/Remover Tool comprising:

A straight pipe with extending brackets on each end. End Brackets support externally threaded shafts by means of a threaded or drilled hole. Externally threaded shafts have a hook and or loop at one end and an internally threaded nut on outward side of frame on opposing end. Reference both externally threaded shafts' loops facing inward of frame end brackets. Connect to vehicle hood spring by slipping externally threaded shaft loop over hook end of spring. A turning force is applied to internally threaded nut and the turning force pulls externally threaded rod outward therefore stretching the spring to a longer position. Spring can then be removed from spring seats on vehicle hinge. A turning force on nut in opposite direction will allow externally threaded shaft to move inward therefore retracting the spring to a shorter position. Can be retracted until spring is at a safe, resting, bound position. Spring can then be removed from loops and or hook of tool. Closable link and a J-Hook is provided for adaptability for varying spring lengths and mounting styles of different automobile manufacturers.

1. Automotive Hood Spring Installer/Remover Tool comprising: Frame -A Straight, square or tubular shaft with extending end brackets on each opposing end. Both End brackets have clearance notches for loops and or hooks and machined holes for externally threaded shaft connections. Two different lengths of externally threaded shafts are utilized. The longer externally threaded shaft is inserted in to machined hole at one end bracket. The shorter externally threaded shaft is inserted in to opposing end bracket hole. The said hook and or loops are made as one piece on one end with said externally threaded shafts. Externally threaded shafts accept two flat washers and an internally threaded hex nut on outward side of said frame end bracket. Externally threaded shafts are parallel to said frame and accept vehicle hood spring in between externally threaded shafts loops and or hooks. Turning force is applied to said internally threaded hex nut on the said longer externally threaded shaft to pull said shaft outward. Therefore stretching vehicle hood spring and allowing removal of vehicle hood spring end from spring seat notch on vehicle hood hinge or vehicle body. Turning force in opposite direction to said internally threaded hex nut will allow vehicle hood spring to retract to springs original bound position. Therefore allowing vehicle hood spring to be released from said loops and or hooks.
The Frame of claim 1 further comprising: Metal or composite tube or solid rod with metal or composite end brackets that extend out.
The Frame of claim 1 further comprising: End brackets are connected or made at a 90 degree angle in relation to said frame tube or rod with one flat surface of end bracket facing length of tube or rod. Said Flat surfaces of said end brackets will face each other to be a stationary pull point for said internally threaded hex nut so the externally threaded shaft can pull outward to stretch hood spring.
The Frame of claim 1 further comprising: Said frame end brackets connection made by weld, braze, fuse, or chemical bond. Frame end brackets and said frame shaft can be manufactured as one piece.
The externally threaded shaft of claim 1 further comprising: Full external threads the length of shafts. A loop or hook on one end of externally threaded shaft is incorporated in the manufacturing of piece. Made of metal of strong strength such as forged steel or hardened steel. Three sizes of externally threaded shafts with tool allow for maximum adaptability for most makes and models of vehicles hood spring servicing.
The internally threaded hex nut of claim 1 further comprising; metal of strong strength such as grade 8, forged steel, hardened steel. A bearing plate or two flat washers used between said internally threaded hex nut and said frame end bracket on externally threaded shaft for decreased wear on device and device parts during use.
The turning force of claim 1 further comprising: Turning force applied is pulling longer externally threaded shaft outward therefore extending said vehicle hood spring. Said internally threaded hex nut is turned using a standard appropriate size hand wrench or ratcheting wrench with turning force applied by user. Turning force is minimal with externally threaded shaft having standard machine threads. Courser threads will increase force needed by user.
The turning force of claim 1 further comprising: A leverage handle connected to said externally threaded shaft on opposing end of said loop and or hook would alleviate internally threaded hex nut when said frame end brackets have an internally threaded said hole. A turning force is applied to said leverage handle to rotate externally threaded shaft to expand and or contract vehicle hood spring when spring engaged in present invention.
The externally threaded shaft of claim 1 further comprising: Connected to said loop end of externally threaded shaft is an openable and closable metal link that extends the overall length of said longer externally threaded shaft. Link is used to accommodate shorter vehicle hood springs that are found on numerous manufactured vehicles. More specifically vehicles from the 1970 era. Link has a threaded hex nut that when loosened allows an opening to insert loop through to connect. After connected, threaded hex nut is tightened to lock connection.

2. An apparatus to mechanically stretch or retract tension coil hood springs for removal and installation on a vehicle hood hinge.
